(19) United States
(12) Patent Application Publication
(10) Pub. No.: US 2004/0172830 A1
(43) Pub. Date: Sep. 9, 2004

(54) Reciprocating type electric shaver

(75) Inventor: Hiromi Uchiyama, Matsumoto (JP)

Correspondence Address: KODA & ANDROLIA, 2029 CENTURY PARK EAST, SUITE 1430, LOS ANGELES, CA, 90067-3024, US

(73) Assignee: IZUMI PRODUCTS COMPANY

(21) Appl. No.: 10/793,418

(22) Filed: Mar. 4, 2004

(30) Foreign Application Priority Data
Mar. 7, 2003 (JP) 2003-061241

(51) Int. Cl. B26B 19/02

(52) U.S. Cl. 30/43.92; 30/346.51

(57) ABSTRACT

A reciprocating type electric shaver that includes an outer cutter, an inner cutter which has a plurality of cutter blades that make sliding contact with the inside surface of the outer cutter, and a driving mechanism which causes the inner cutter to make a reciprocating motion in the direction of length of the outer cutter; wherein the outer cutter is formed in a concave or inwardly curved shape so that the central portion in the lengthwise direction of the outer cutter is raised. The shaver can have two outer cutters side by side so that one of the outer cutters has the inwardly curved shape, and the other has a convex or outwardly curved shape or a rectilinear shape.

### BACKGROUND OF THE INVENTION

1. Field of the Invention

The present invention relates to an electric shaver and more particularly to a reciprocating type electric shaver.

2. Prior Art

A reciprocating type electric shaver cuts (or shaves) hair between an outer cutter and inner cutter by driving the inner cutter in a reciprocating manner (in the direction of length of the outer cutter) along the inside surface of an outer cutter that has an inverted U shape.

FIG. 7(a) shows one example of an electric shaver in which two outer cutters 10 are disposed side by side, and FIG. 7(b) shows an example in which a single outer cutter 10 is provided. Ordinarily, the top portion (or ridge line) of the outer surface of each outer cutter 10 is in a rectilinear shape or straight as shown in FIG. 7(a); and in some electric shavers, the top portion of the outer surface of the outer cutter 10 is in a shape that bulges outward, so that the top portion has a convex shape that protrudes outward, as shown in, for example, Japanese Patent Application Laid-Open (Kokai) No. H5-49760.

If the top portion of the outer surface of the outer cutter is rectilinear or straight as shown in FIG. 7(a), or if the top portion of the outer cutter is formed so that it protrudes or curved outward as shown in FIG. 7(b), some problems arise. When a curved portion of, for instance, the face such as the jaw is shaved (see FIG. 5(a)), the outer cutter 10 makes only partial contact with the skin. As a result, shaving stubble is generated, and efficient shaving is performed.

### SUMMARY OF THE INVENTION

Accordingly, the present invention is to solve the problems in the reciprocating type electric shavers in prior art.

The object of the present invention is to provide an easy-to-use reciprocating type electric shaver that performs efficient shaving without causing any shaving stubble, etc. by allowing the outer cutter to make a close contact with the skin even in cases where curved portions such as the jaw, etc. are shaved.

The above object is accomplished by a unique structure of the present invention for a reciprocating type electric shaver that includes an outer cutter, an inner cutter which has a plurality of cutter blades that make sliding contact with the inside surface of the outer cutter, and a driving mechanism which causes the inner cutter to make a reciprocating motion in the direction of length of the outer cutter; and in the present invention, the top portion of the outer cutter is formed in a concave shape or inwardly curved shape.

In this structure, the outer cutter can be provided at two locations that are parallel or side by side; and the top portion of the outer cutter that is at one of the two locations has the concave shape, and the top portion of the outer cutter that is at another one of the two locations has either a convex shape or a rectilinear shape.

With the structure above, the outer cutter that has a concave or inwardly curved shape (top portion) is used for curved portions such as the jaw, etc., the outer cutter that has a convex or outwardly curved shape (top portion) is used for recessed areas such as the area under the jaw, etc., and the outer cutter that has a rectilinear or straight shape (top portion) is used for flat areas such as the cheeks, etc.

In the above structure of the reciprocating type electric shaver of the present invention,

the cutter blades of the inner cutter that make sliding contact with the inner surface of the outer cutter in a concave, convex or rectilinear shape are provided on a cutter blade supporting body so that the cutting edges of the cutter blades are arranged in a shape that is in conformity to the shape of the top portion of the outer cutter of the concave, convex or rectilinear shape, and

the driving mechanism that causes this inner cutter to make a reciprocating motion is provided so that the inner cutter makes a reciprocating motion in conformity to the shape of the top portion of the outer cutter of the concave, convex or rectilinear shape.

In addition, in the reciprocating type electric shaver of the present invention that has the above structure, the driving mechanism includes:

a reciprocating drive shaft on which the cutter blade supporting body is provided,

a guide shaft which is formed in a shape that coincides with the shape of the top portion of the outer cutter of the concave, convex or rectilinear shape so that the guide shaft guides, via the reciprocating drive shaft, the motion of the inner cutter in conformity to the shape of such outer cutter, and

a conversion mechanism that converts the rotational motion of the output shaft of a driving motor into a reciprocating motion that causes the reciprocating drive shaft to make a reciprocating motion in the direction of length of the outer cutter.

### BRIEF DESCRIPTION OF THE DRAWINGS

FIGS. 1(a) and 1(b) are perspective views of the outer cutters of the reciprocating type electric shaver according to one embodiment of the present invention;

FIGS. 2(a), 2(b) and 2(c) are explanatory diagrams of the outer cutters of the shaver shown in FIG. 1;

FIGS. 3(a), 3(b) and 3(c) are explanatory diagrams of the inner cutters of the shaver shown in FIG. 1;

FIGS. 4(a) and 4(b) are explanatory diagrams showing the construction that causes the inner cutters to make a reciprocating motion in a curvilinear manner in conformity to the shape of the inside surfaces of the outer cutters;

FIGS. 5(a) and 5(b) show the manner of shaving with a reciprocating type electric shaver according to the present invention;

FIGS. 6(a) and 6(b) show another configuration of the outer cutters according to the present invention; and

FIGS. 7(a) and 7(b) show the outer cutters in conventional reciprocating type electric shavers.

### DETAILED DESCRIPTION OF THE INVENTION

Embodiments of the present invention will be described in detail below.

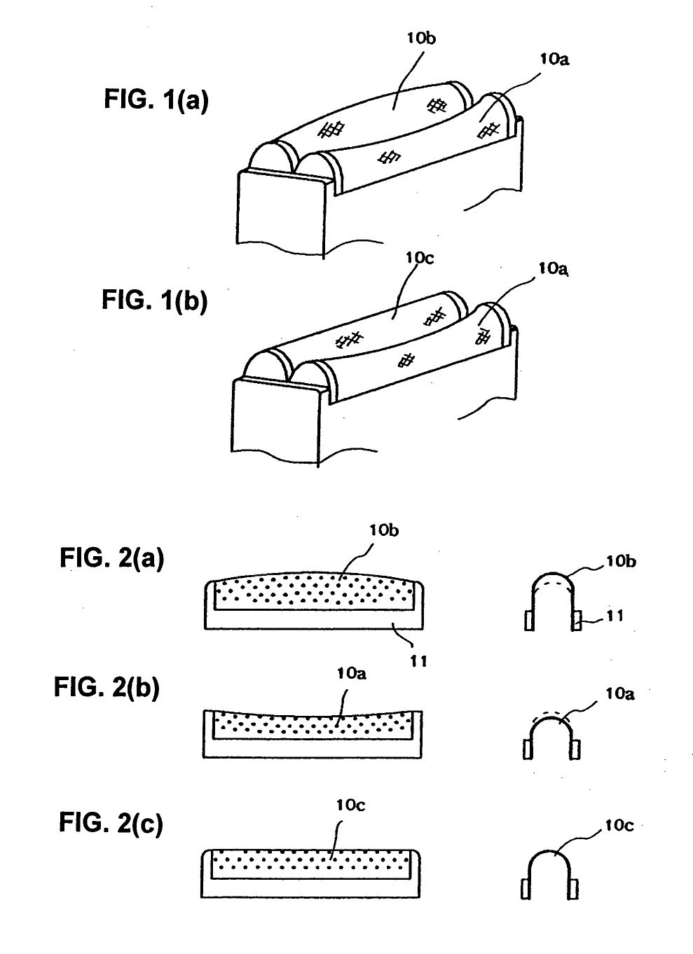

In the reciprocating type electric shaver of the embodiment shown in FIGS. 1(a) and 1(b), two outer cutters are disposed side by side, and the top portion (or the ridge line) of the outer surface that forms the shaving surface of one of the outer cutters is formed so that the top portion is bent in a concave shape that protrudes or curves inwardly.

In the reciprocating type electric shaver shown in FIG. 1(a), the top portion of one outer cutter 10a is formed so that it is bent in a concave shape that protrudes inward and thus in an inwardly curved shape, and the top portion of the other outer cutter 10b is formed so that it is bent in a convex shape that protrudes outward and thus in an outwardly curved shape. In the shaver shown in FIG. 1(b), the top portion of one outer cutter 10a is formed so that its top portion is in a concave or inwardly curved shape, while the top portion of the other outer cutter 10c is straight or in a rectilinear shape.

In other words, the (top portion or ridge line of the) central portion in lengthwise direction (substantially the left to right direction in FIG. 1(a)) of the outer cutter 10a is lower than both end portions thereof, and the (top portion or ridge line of the) central portion in lengthwise direction of the outer cutter 10b is higher than both end portions thereof.

FIGS. 2(a) through 2(c) show only the outer cutters (which are replaceable elements) used in the reciprocating type electric shaver. FIG. 2(a) shows the outer cutter 10b in which the central portion of the outer cutter has a convex or outwardly curved shape, FIG. 2(b) shows the outer cutter 10a in which the central portion of the top portion of the outer cutter has a concave or inwardly curved shape, and FIG. 2(c) shows the outer cutter 10c in which the top portion of the outer cutter has a rectilinear or straight shape. Each of FIGS. 2(a) through 2(c) shows, on the left side, the shape of the outer cutter seen from the front and, on the right side, the cross-section taken through the central portion of each outer cutter with respect to the direction of length.

Since the outer cutters of the reciprocating type electric shaver are replaceable, the electric shaver equipped with the outer cutters shown in FIGS. 1(a) and 1(b) can be provided by appropriately setting the outer cutters shown in FIGS. 2(a) through 2(c) and appropriately setting the corresponding inner cutters that are used in accordance with these outer cutters.

In the reciprocating type electric shaver, shaving is done by causing the inner cutters to make a reciprocating motion inside the outer cutters in the direction of length of the outer cutters or sideways. When the outer cutters shown in FIGS. 2(a) through 2(c) are used, inner cutters in which the cutter blades are disposed in conformity to the shapes of the outer surfaces of the top portions of the outer cutters are used.

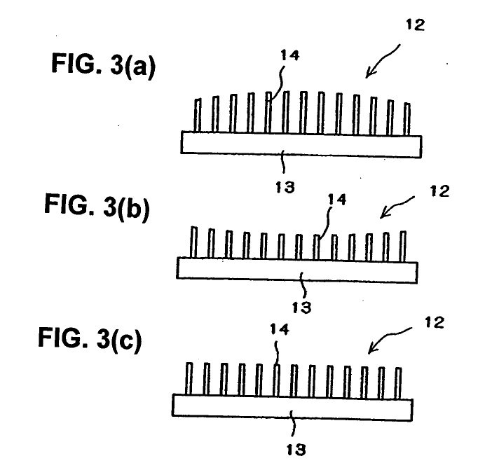

FIGS. 3(a), 3(b) and 3(c) respectively show the inner cutters 12 that are used with the outer cutters shown in FIGS. 2(a), 2(b) and 2(c).

The inner cutters 12 are formed so that cutter blades 14 are attached at specified intervals to a cutter blade supporting body 13 so that the cutting edges (top edges) of the cutter blades 14 comply with the shapes of the outer surfaces of the top portions of the curved or straight outer cutters (or the shapes of the inside surfaces of the outer cutters).

In the structure of FIG. 3(a), the cutter blades 14 gradually decrease in height thereof towards both ends of a straight (or not-curved) cutter blade supporting body 13 so that an imaginary line connecting the cutting edges of the cutter blades 14 form a convex or outwardly curved shape as in the shape of the outer cutter 10b of FIG. 2(a). In the structure of FIG. 3(b), the cutter blades 14 gradually increase in height thereof towards both ends of a straight cutter blade supporting body 13 so that an imaginary line connecting the cutting edges of the cutter blades 14 form a concave or inwardly curved shape as in the shape of the outer cutter 10a of FIG. 2(b). In the structure of FIG. 3(c), all the cutter blades 14 are substantially the same in height on a straight cutter blade supporting body 13 so that an imaginary line connecting the cutting edges of the cutter blades 14 form a straight shape as in the shape of the outer cutter 10c of FIG. 2(c).

Each cutter blade supporting body 13 is provided on a reciprocating drive shaft (described later) which is driven in a reciprocating manner in the direction of length of the outer cutter (such direction being in the left to right directions in FIGS. 3(a) through 3(b)) by a driving mechanism equipped with a driving motor, etc., that is installed in the main body of the electric shaver (not shown).

Since the movement distance during the reciprocating motion of the inner cutters 12 is small, i.e., approximately 2 mm, the inner cutters, which form a curved line along the cutting edges thereof, can be caused to make a reciprocating motion in sliding contact with the inside surfaces of the outer cutters by means of an ordinary driving mechanism in which the reciprocating drive shafts make a reciprocating motion (rectilinear reciprocating motion) parallel to the outer cutters by a driving motor, if a material that has a slight elasticity is used for the cutter blade supporting bodies 13.

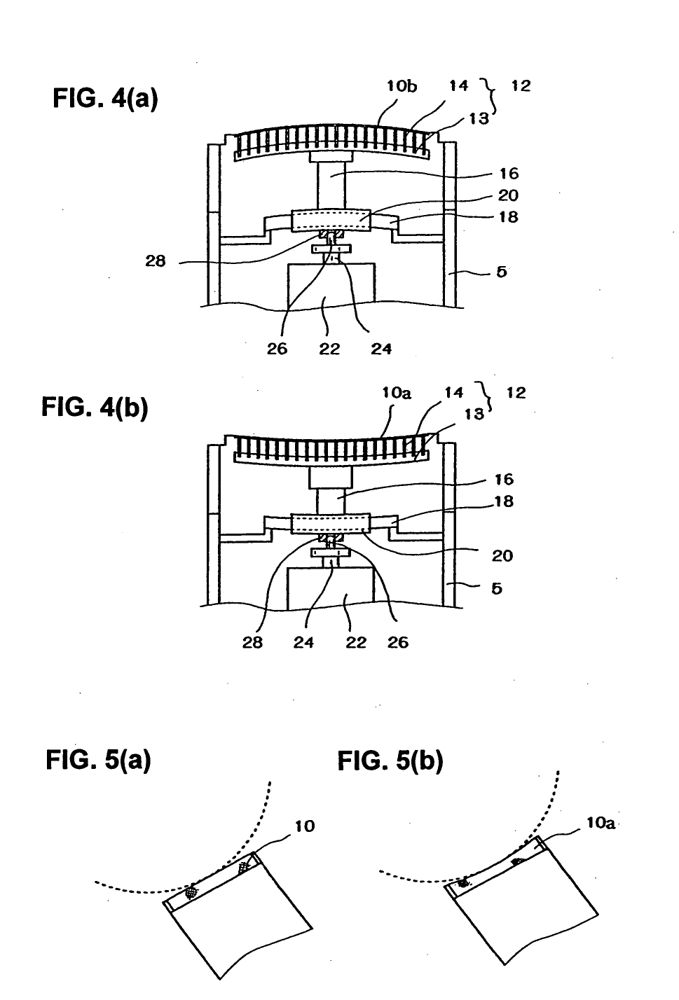

The top portions of the outer cutters of the present invention have a convex shape that protrudes outward or a concave shape that protrudes inward as shown in FIGS. 2(a) or 2(b), and the inner cutters 12 are caused to make a reciprocating motion in a curvilinear manner in conformity to the curved surface shape of the outer cutters by the driving mechanism shown in FIGS. 4(a) or 4(b). FIG. 4(a) shows the structure used for the outer cutter 10b that is in a convex or outwardly curved shape, while FIG. 4(b) illustrates the structure for the outer cutter 10a that is in a concave or inwardly curved shape.

The cutter blade supporting body 13 of the inner cutter 12 shown in FIG. 4(a) is formed so that it is bent in a convex or outwardly curved shape, while the cutter blade supporting body 13 of the inner cutter 12 shown in FIG. 4(b) is in a concave or inwardly curved shape. Each cutter blade supporting body 13 having thereon the cutter blades is fastened to a reciprocating drive shaft 16, and this reciprocating drive shaft 16 is fastened at the base position to a guide body 20 which makes a reciprocating motion while being guided by a guide shaft 18.

The guide shaft 18 guides the reciprocating drive shaft 16 so that the inner cutter 12 makes a reciprocating motion in conformity to the shape of the outer cutter.

More specifically, in FIG. 4(a), the overall shape of the outer cutter 10b is a circular-arc (outwardly curved) arc shape, the cutter blades 14 of substantially identical in height to each other are provided on the cutter blade supporting body 13 that is in a convex or outwardly curved shape having the same curvature as that of the outer cutter 10b, the guide shaft 18 is likewise formed in a circular-arc (outwardly curved) shape, and the curvature and disposition of the guide shaft 18 are set so that the center of the curvature of the outer cutter 10b and the center of the curvature of the guide shaft 18 coincide with each other.

The guide shaft 18 is fastened to the main body 5 of the electric shaver, and the guide body 20 is provided so as to slide back and forth (or sideways in FIG. 4(a)) along the guide shaft 18. Consequently, as the guide body 20 makes a reciprocating motion, the inner cutter 12 reciprocates while making sliding contact with the inside surface of the outer cutter 10b.

In FIG. 4(b), the outer cutter 10a is in a circular-arc (inwardly curved), the cutter blades 14 of substantially identical in height to each other are provided on the cutter blade supporting body 13 that is in a concave or inwardly curved shape having the same curvature as that of the outer cutter 10b, the guide shaft 18 is formed likewise in a circular-arc (inwardly curved) shape, and the installation position of the guide shaft 18 is stipulated, so that the center of the curvature of this guide shaft 18 coincides with the center of the curvature of the outer cutter 10a. Consequently, as the guide body 20 makes a reciprocating motion over the guide shaft 18, the inner cutter 12 reciprocates while making sliding contact with the inside surface of the outer cutter 10a.

In the driving mechanism of each one of the structures of FIGS. 4(a) and 4(b) that causes the guide body 20 to make a reciprocating motion, an eccentric pin 26 is attached to the output shaft 24 of the driving motor 22, and this eccentric pin 26 is engaged with an engagement portion 28 that is fastened to the guide body 20. A slot through which the eccentric pin 26 slides (while engaged) is formed in the engagement portion 28 in an orientation that is perpendicular to the direction of the reciprocating motion of the guide body 20. As a result of the rotation of the eccentric pin 26 while the eccentric pin 26 and engagement portion 28 are engaged, the rotational motion of the eccentric pin 26 is converted into a reciprocating motion of the guide body 20.

The conversion mechanism that converts the rotational motion into a rectilinear reciprocating motion is not limited to the construction describe above, and any structure can be take as long as it provides such a conversion.

With the driving mechanism for the inner cutter 12 as shown in FIGS. 4(a) and 4(b), shaving is made by the inner cutters that reciprocate in conformity to the inside surfaces of the outer cutters in a reciprocating type electric shaver in which the outer cutters are in a convex or concave shape as described above and the inner cutters reciprocate in a curvilinear manner (circular-arc shape) in conformity to the curvilinear shape (circular-arc shape) of (the top portions of) such outer cutters.

With an electric shaver that is equipped with an outer cutter 10a in which the shape of the top portion of the outer cutter is concave as shown in FIG. 1(a), the outer cutter 10a contacts the skin in conformity to the curved shape of the jaw, etc., when curved areas such as the jaw, etc. are shaved as shown in FIG. 5(b). Accordingly, efficient shaving is performed, and suitable shaving with no remaining shaving stubble is accomplished.

The reciprocating type electric shavers shown in FIGS. 1(a) and 1(b) are respectively a combination of the outer cutter 10a in a concave or inwardly curved shape and the outer cutter 10b in a convex or outwardly curved shape and a combination of the outer cutter 10a in a concave or inwardly curved shape and the outer cutter 10c in a rectilinear shape. Accordingly, in these shavers, when curved portions such as the jaw, area under the jaw and neck area, etc. are shaved, the outer cutter 10a in the concave or inwardly curved shape is brought to contact the skin; and when flat portions such as the cheeks, etc. are shaved, the outer cutter 10b in a convex or outwardly curved shape or in rectilinear shape is caused to contact the skin. Accordingly, even more suitable shaving is performed by way of using the outer cutters differently.

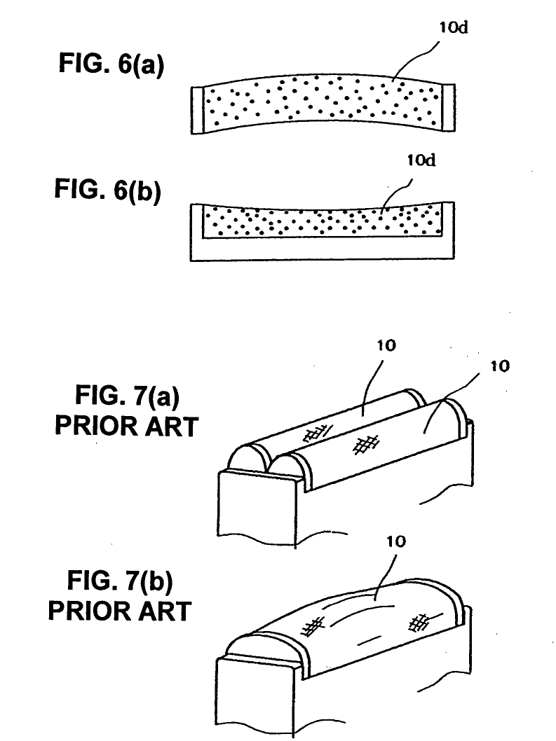

In the embodiments described above, the outer cutter 10a in a concave or inwardly curved shape and the other outer cutters 10b and 10c are rectilinear when seen from the top, and the inner cutters 12 that make a reciprocating motion while making sliding contact with the inside surfaces of such outer cutters reciprocate in a rectilinear manner when seen from the top. The reciprocating type electric shaver of the present invention is not limited to outer cutters of rectilinear shape in a plan view; and an action and effect similar to those described above is obtained in an outer cutter 10d which has a curved configuration when seen from the top as shown in FIG. 6(a) by forming the (top portion of the) outer cutter 10d in a curved shape. FIG. 6(a) shows the outer cutter 10d in a plan view, and FIG. 6(b) shows the outer cutter 10d in a front view.

As seen from the above, in the reciprocating type electric shaver of the present invention, the shape of the top portion of the outer surface of the outer cutter is in a concave or inwardly curved shape. Accordingly, the shaver has conspicuous advantages. Namely, the outer cutter is securely pressed against the skin when curved portions such as the jaw, etc. are shaved, so that efficient shaving that leaves no shaving stubble, etc. is accomplished.

1. A reciprocating type electric shaver comprising an outer cutter, an inner cutter which has a plurality of cutter blades that make sliding contact with an inside surface of said outer cutter, and a driving mechanism which causes said inner cutter to make a reciprocating motion in a direction of length of said outer cutter, wherein a top portion of said outer cutter is curved in a concave shape.

2. The reciprocating type electric shaver according to claim 1, wherein said outer cutter is provided at least two locations that are disposed side by side, a top portion of said outer cutter that is at one of said at least two locations has said concave shape, and a top portion of said outer cutter that is at another one of said at least two locations has a shape other than said concave shape.

3. The reciprocating type electric shaver according to claim 2, wherein said shape other than said concave shape is one selected from a convex shape and a rectilinear shape.

4. The reciprocating type electric shaver according to claim 1 or 2, wherein
said plurality of cutter blades are provided on a cutter blade supporting body so that cutting edges of said plurality of cutter blades are in conformity to a curved shape of said top portion of said outer cutter, and
a driving mechanism that causes said inner cutter to make a reciprocating motion is provided so that said inner cutter makes a reciprocating motion in conformity to said shape of said top portion of said outer cutter.

5. The reciprocating type electric shaver according to claim 4, wherein
said plurality of cutter blades on said cutter blade supporting body are provided so that cutting edges of said plurality of cutter blades forms a curvature that is substantially same as a curvature of said top portion of said outer cutter in said concave shape.

6. The reciprocating type electric shaver according to claim 4, wherein
said plurality of cutter blades on said cutter blade supporting body are provided so that cutting edges of said plurality of cutter blades forms a curvature that is substantially same as a curvature of said top portion of said outer cutter in said convex shape.

7. The reciprocating type electric shaver according to claim 5, wherein
said conformity to said shape of said top portion of said outer cutter is obtained by said plurality of cutter blades which are provided on said cutter blade supporting body and are different in height.

8. The reciprocating type electric shaver according to claim 6, wherein
said conformity to said shape of said top portion of said outer cutter is obtained by said plurality of cutter blades which are provided on said cutter blade supporting body and are different in height.

9. The reciprocating type electric shaver according to claim 5, wherein
said conformity to said shape of said top portion of said outer cutter is obtained by said plurality of cutter blades which are provided on said cutter blade supporting body that is curved and are substantially identical in height.

10. The reciprocating type electric shaver according to claim 6, wherein
said conformity to said shape of said top portion of said outer cutter is obtained by said plurality of cutter blades which are provided on said cutter blade supporting body that is curved and are substantially identical in height.

11. The reciprocating type electric shaver according to claim 4, wherein said driving mechanism comprises:
a reciprocating drive shaft on which said cutter blade supporting body is provided,
a guide shaft which is formed in a shape that coincides with said shape of said top portion of said outer cutter so that said guide shaft guides, via said reciprocating drive shaft, a motion of said inner cutter in conformity to said shape of said outer cutter, and
a conversion mechanism that converts a rotational motion of an output shaft of a driving motor into a reciprocating motion that causes said reciprocating drive shaft to make a reciprocating motion in a direction of length of said outer cutter.
